(19) United States
(12) Patent Application Publication
(10) Pub. No.: US 2019/0342626 A1
(43) Pub. Date: Nov. 7, 2019

(54) Method of Implementing A Peer-To-Peer On-Demand Live Video Streaming Service

(71) Applicant: Andres Hernandez, Coral Gables, FL (US)

(72) Inventor: Andres Hernandez, Coral Gables, FL (US)

(21) Appl. No.: 16/402,223

(22) Filed: May 2, 2019

Related U.S. Application Data
(60) Provisional application No. 62/665,992, filed on May 2, 2018.

(51) Int. Cl. H04N 21/63; H04N 21/472; H04N 21/45; H04N 21/2187; G01C 21/34

(52) U.S. Cl. CPC H04N 21/632; H04N 21/47211; G01C 21/3407; H04N 21/4532; H04N 21/2187; H04N 21/47202

(57) ABSTRACT

A method of implementing a peer-to-peer on-demand live video streaming service allows users to place a request for a live video streams with various specifications, such as location and time. Another user may accept the request, travel to the specified location at the specified time, and initiate a live video stream from the camera of their computing device to the computing device of the requesting user in a peer-to-peer arrangement. The viewer and streamer may communicate with each other through text, audio, or other means during the live stream. Streamers may be offered streaming requests based on their proximity to the stream location. Viewers may have to pay for the live streaming service, and streamers may be paid for performing the service.

The current application claims a priority to the U.S. Provisional Patent application Ser. No. 62/665,992 filed on May 2, 2018.

### FIELD OF THE INVENTION

The present invention generally relates to video streaming. More specifically, the present invention relates to a mobile application for peer-to-peer remote on-demand live video streaming.

### BACKGROUND OF THE INVENTION

Video streaming has revolutionized the way people can experience live events without having to be physically present at the event. Many websites and applications have allowed people to remotely view events such as concerts or public speeches live, whereas in the past many would have missed an event if they would be unable to be physically present. While the amount of video live streams is increasing, the availability of most video live streams is often limited to major events or popular events. It is easier for people to find a video live stream of a major event, such as a sports game or a musical, than finding a video live stream of a regular event, such as the opening of a museum or a community garden. Furthermore, the live stream schedule largely depends on the event's producers, which further limits the availability of video live streams to people as many stream schedules conflict with people's schedules. Fortunately, newer video live streams of non-major events have been increasing in popularity as more media applications allow for everyday people to stream their everyday activities. While these video live-streaming capabilities of media applications increase the amount of available video live streams and the type of video live streams, available video live streams are still limited to the schedules and locations the creators choose which may not match the viewer's desires. This leaves people with few options of watching video live streams of their desired location and event at a date and time which fit their schedules. Thus, an on-demand video live stream service which allows people to remotely watch an event at desired location, date, and time is beneficial and necessary.

An objective of the present invention is to provide systems and methods for on-demand video live stream services. The present invention allows users to order a video live stream anywhere, anytime. The present invention comprises an application which allows a first user to send a request for a video live stream to a second user at a certain location defined by the first user. No other device is needed unless first user requests a special recording device. Both first user and second user will just use the application of the present invention on their portable device to respectively see or record. The first user and the second user are not required to physically meet each other, the application of the present invention will connect them together based on the distance of the second user to the first user, preferably through geolocation. There is no limit to how far the first user is from the location of the requested recording.

### SUMMARY OF THE INVENTION

The present invention is a method for an on-demand peer-to-peer live video streaming service. The present invention is an application for computing devices, and may be alternatively known as “LUCY.” A viewer can send an immediate request or a request for a live stream anytime in the future. A streamer located in a defined radius will receive a notification and will have a limited time to accept or reject it. If the streamer accepts the request, the application of the present invention will show the streamer the location of the request. Both streamer and viewer can communicate with each other during the live stream through a build-in communication channel in the application of the present invention. The streamer can choose to stay “Available” or “Not-available”, depending on the streamer's readiness to accept requests at any moment. The viewer will have to pay for each live stream. At the end of the stream, the viewer will have the option to purchase and download the full video of the live stream for an additional cost. The app will pay the streamer for each recording service. Both the streamer and viewer may submit a review of the other after each service.

### BRIEF DESCRIPTION OF THE DRAWINGS

FIG. 1 is a diagram illustrating the process of requesting a video live stream on the application of the present invention.

FIG. 2 is a diagram illustrating the process of requesting a video live stream on the application of the present invention.

FIG. 3 is a diagram illustrating the payment options for stream services on the application of the present invention.

FIG. 4 is a diagram illustrating the assignment process on the application of the present invention.

FIG. 5 is a diagram illustrating the video live stream process on the application of the present invention.

FIG. 6 is a diagram illustrating the options available after the end of the stream services on the application of the present invention.

FIG. 7 is a stepwise flow diagram illustrating the general method of the present invention.

FIG. 8 is a stepwise flow diagram illustrating steps for specifying a service type and the specified radius to the stream location in the method of the present invention.

FIG. 9 is a stepwise flow diagram illustrating steps for selecting the confirmed streamer profile in the method of the present invention.

FIG. 10 is a stepwise flow diagram illustrating steps for setting an availability designation in the method of the present invention.

FIG. 11 is a stepwise flow diagram illustrating steps for establishing and ending the live video stream in the method of the present invention.

FIG. 12 is a stepwise flow diagram illustrating steps for communication between the streamer and the viewer in the method of the present invention.

FIG. 13 is a stepwise flow diagram illustrating steps for navigating the streamer to the stream location and alerting the viewer of their arrival in the method of the present invention.

FIG. 14 is an illustration of the interface of the application of the present invention. The log-in, sign-up, and homepage of the application of the present invention are shown. The plurality of payment options is illustrated.

FIG. 15 is an illustration of the application of the present invention. The request for stream services is shown on the interface of the application of the present invention.

FIG. 16 is an illustration of the application of the present invention. The interface shown to the second user on the application of the present invention is shown.

FIG. 17 is an illustration of the application of the present invention. The process of video live stream on the application of the present invention is shown. The plurality of options to increase credits during a video live stream is shown.

FIG. 18 is an illustration of the application of the present invention. An additional window interface shown to the first user and second user before/after a stream service is illustrated.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

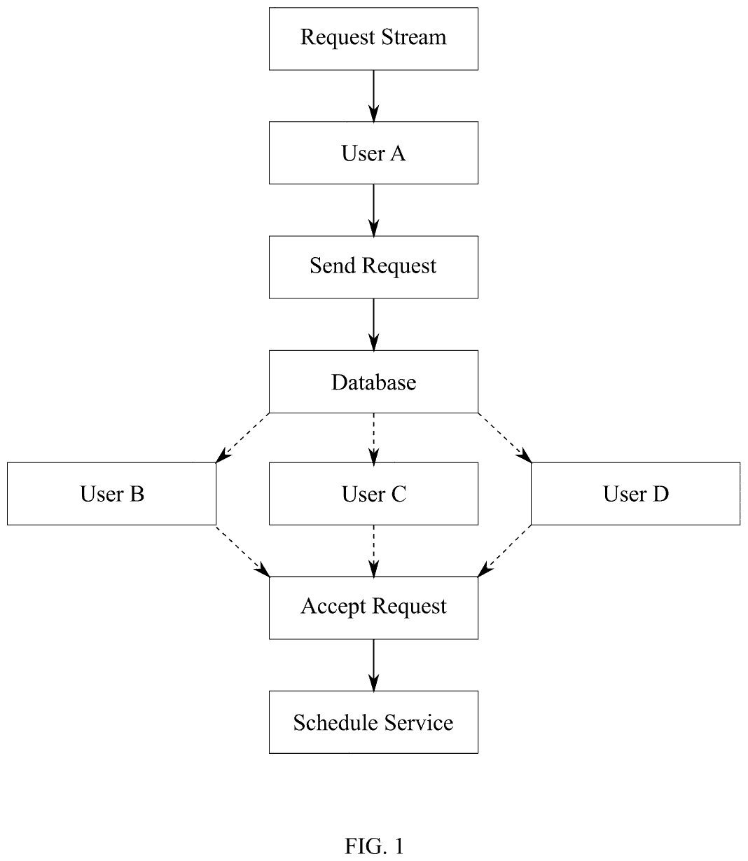

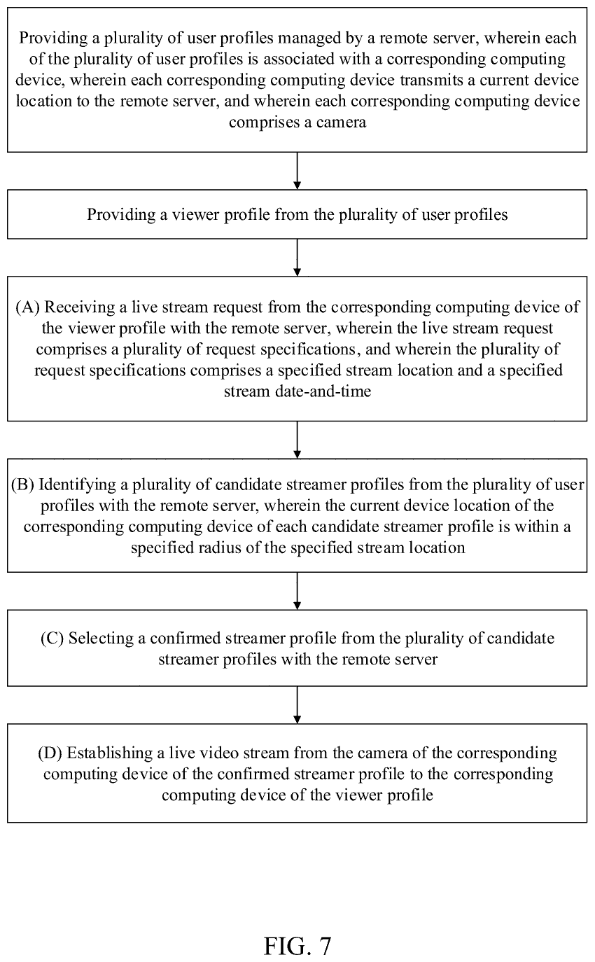

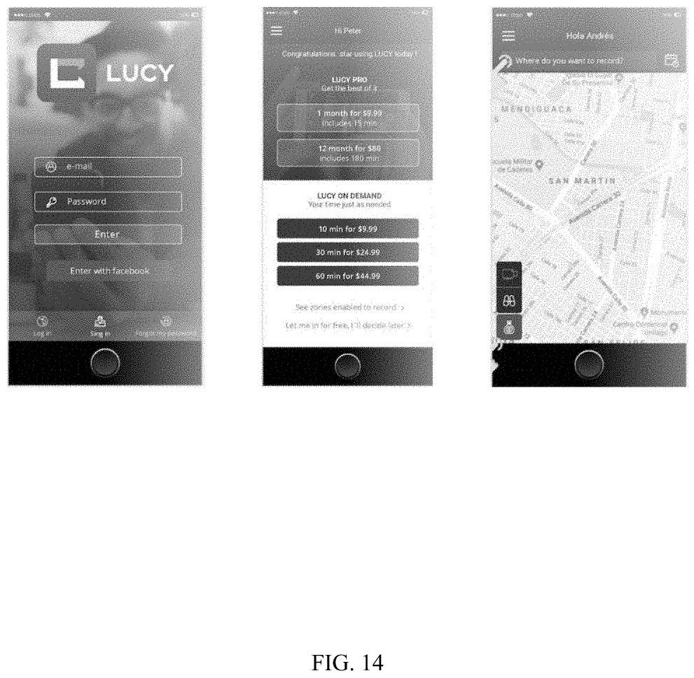

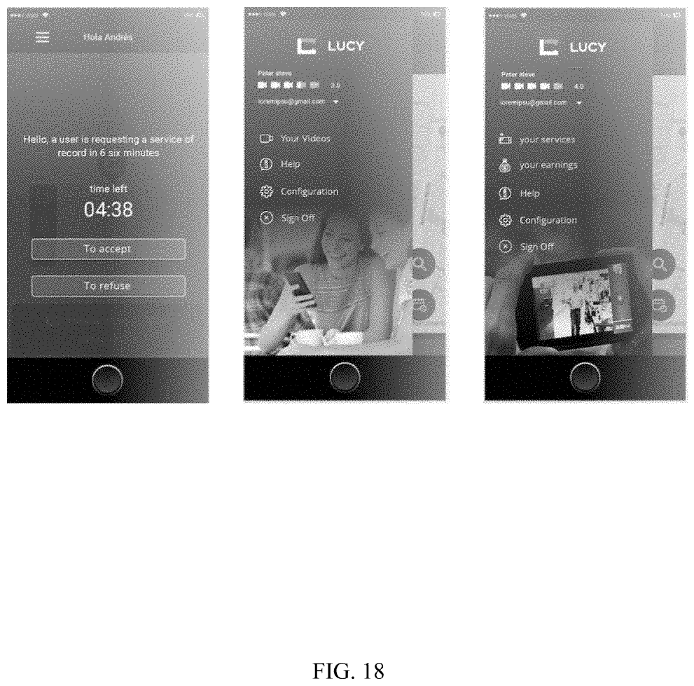

The present invention is a method for implementing a peer-to-peer on-demand live video streaming service. The present invention allows users to order a live stream anywhere, anytime through an application. The present invention allows a user to request a live video stream of a desired location, event, or other relevant item, thus being able to observe the location/event/etc remotely. For example, someone in California may wish to view a live stream of Times Square in New York. In another example, a user may wish to observe a musical act performing in a public park, but is unable to leave their house. Thus, the user may request a live stream of the musical performance, in response to which another user travels to the park and streams live video of the performance through the camera of their mobile device to the requester's device. FIGS. 1-6 illustrate general process flows carried out by the present invention. FIGS. 7-13 describe the method of the present invention. FIGS. 14-18 illustrate exemplary embodiments as implemented in a mobile device application.

In the preferred embodiment of the present invention, the application of the present invention is a software application comprising various embodiments including, but not limited to, desktop applications, mobile applications, cloud applications, and any other relevant application types. In some embodiments of the present invention, the present invention can be accessed through a third-party application, such as search engine or internet browser, in the form of a widget, add-on, extension, etc. The application of the present invention can be installed or accessed through an electronic device which can wirelessly access the Internet, such as a laptop, computer, mobile phone, tablet, etc. In the preferred embodiment of the present invention, the application of the present invention includes various windows and menus which are displayed to the user providing different features and/or options available to the users. The application of the present invention comprises two main user roles: viewers and streamers. Viewers request live video streams, while streamers record and stream live video to the viewers in order to fulfill the viewers' requests. In various embodiments, viewers and streamers may be separated into distinct user types, or any given user may fulfill either a viewer or a streamer role. In the preferred embodiment of the present invention, any given streamer only transmits a live video feed to a single viewer. In the preferred embodiment, viewers are required to pay in currency to initiate a stream request, while streamers are paid for their service. Payment means and methods may vary in different embodiments.

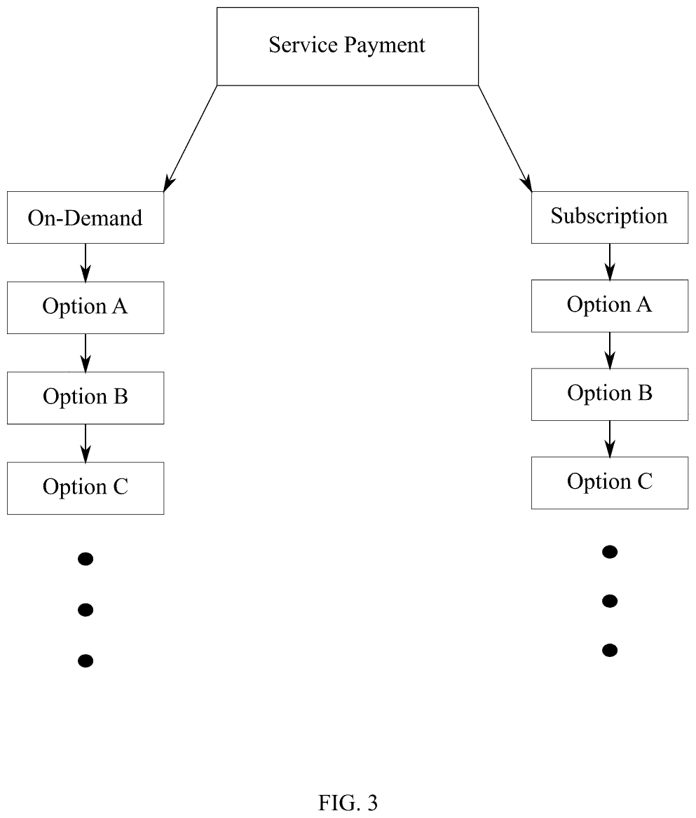

In some embodiments of the present invention, the application of the present invention provides a sign-up and/or log-in screen where users can become members of the services of the present invention or provide their log-in information to access the application. The application of the present invention can further allow users to link a third-party account with the present invention. By linking accounts, the users can allow various information to be shared between the third-party applications and the present invention. When creating a new account or modifying payment methods, the application provides users with a screen where users can choose and select various payment options. Preferably, the application provides users with a plurality of payment options to choose from. In some embodiments, the present invention allows users to select from a demand option or a subscription option, as shown in FIG. 3. Furthermore, each option may provide a plurality of tiers for the user to choose from according to their desires. A subscription option may provide various subscription tiers corresponding to different subscription periods of time. The different subscription tiers may provide a set amount of credits corresponding to periods of time which limit the duration of the requested video live stream. The set amount of credits for the subscription tiers can be replenished after the users have finished them. An on-demand option may provide various tiers corresponding to different time packages corresponding to different amounts of credits or periods of time for which the users can request the video live streams to last. The different tiers of the on-demand option may be replenished at any time. In the preferred embodiment, the users can further sign-up to provide the video live stream services for other users to watch. Users are paid for the amount of video live stream services performed as well as for their performance based on reviews submitted by users. In alternate embodiments of the present invention, the payment options can include different payment options and different tiers. Streamers may be paid per specified increment of streaming time; for example, per second or per minute of streaming. The total amount paid to streamers may be calculated once the live stream is finished.

Referring to FIG. 7, In the general method of the present invention, a plurality of user profiles is provided, and the plurality of user profiles is managed by a remote server. The remote server is considered to be the primary managing entity of the present invention, enabling and managing connections between users. Each of the plurality of user profiles is associated with a corresponding computing device. The corresponding computing device may generally be understood to be a mobile device such as, but not limited to, a smartphone or tablet, though any relevant device may be utilized, such as a laptop computer, if its configuration allows. Further, each corresponding computing device transmits a current device location to the remote server, and each corresponding computing device comprises a camera.

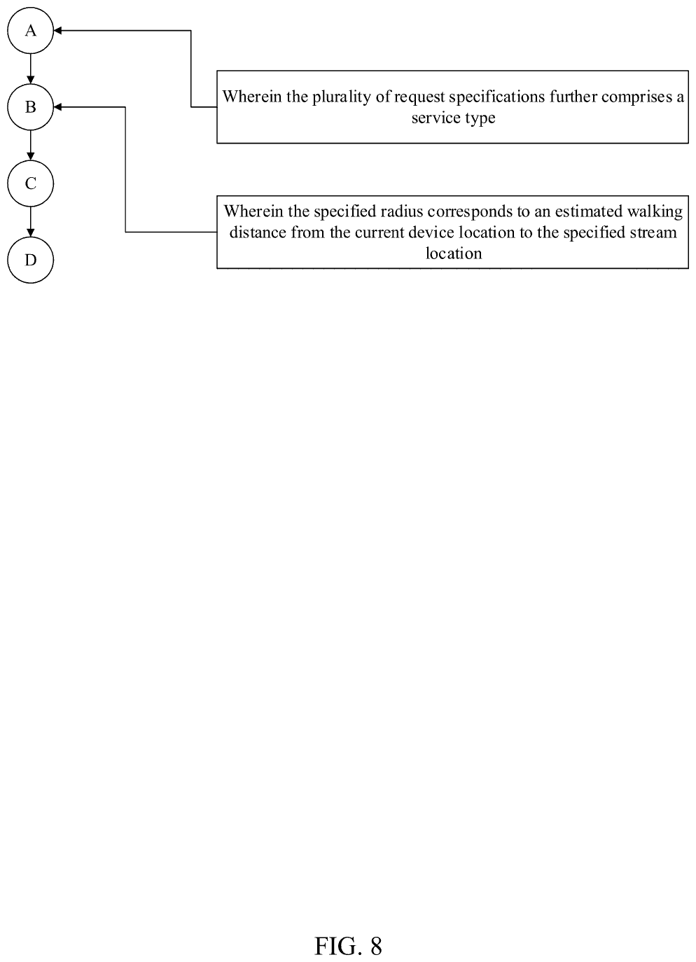

A viewer profile is further provided from the plurality of user profiles. A live stream request is received from the corresponding computing device of the viewer profile with the remote server (Step A), wherein the live stream request comprises a plurality of request specifications. The plurality of request specifications simply represents any details germane to the live stream request, such as, but not limited to, a specified stream location and a specified stream date-and-time. The plurality of request specifications may further comprise any other relevant specification, such as a service type, as seen in FIG. 8, or instructions to the streamer as to how to conduct the live stream.

A plurality of candidate streamer profiles is then identified from the plurality of user profiles with the remote server (Step B), wherein the current device location of the corresponding computing device of each candidate streamer profile is within a specified radius of the specified stream location. In some embodiments, the specified radius may correspond to an estimated walking distance from the current device location to the specified stream location. For example, if the live stream request is for an immediate stream, the specified radius may be an estimated ten minute walk, or if the live stream request is to schedule a future stream, the specified radius may be an estimated two hour walk, providing of course that the stream request is to be scheduled more than two hours in the future.

A confirmed streamer profile is then selected from the plurality of candidate streamer profiles with the remote server (Step C). The specific means through which the confirmed streamer profile is selected may vary in different embodiments, but in the preferred embodiment, the confirmed streamer profile is selected by proximity to the specified stream location. The closest streamer is given an opportunity to accept the live stream request, and they can either accept or reject it. If they reject it, the next closest streamer is offered the streaming job, and so on.

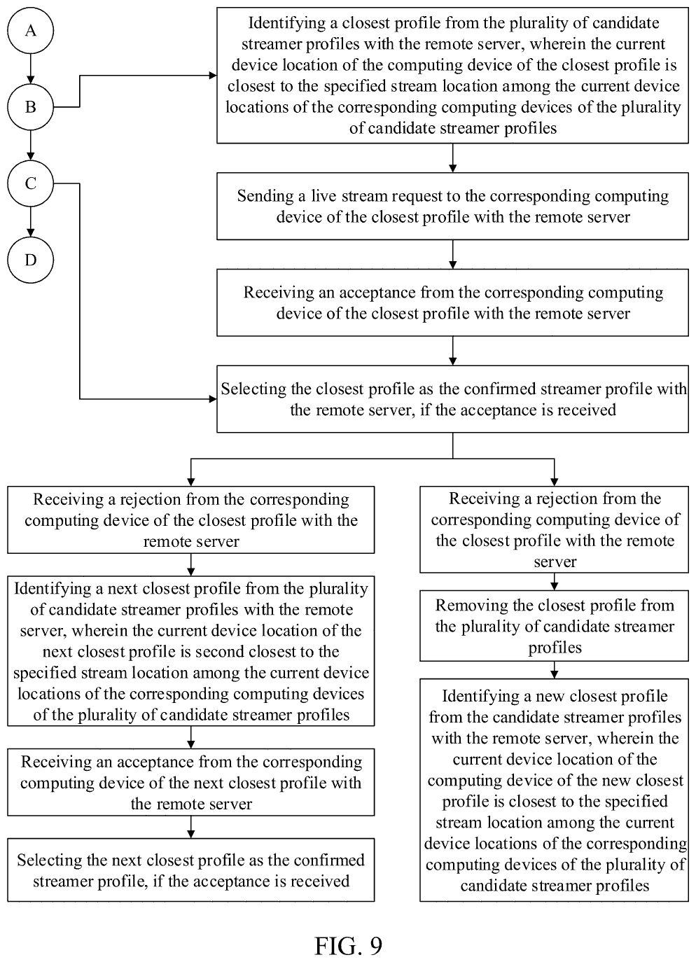

More particularly, as seen in FIG. 9, a closest profile is identified from the plurality of candidate streamer profiles with the remote server, wherein the current device location of the computing device of the closest profile is closest to the specified stream location among the current device locations of the corresponding computing devices of the plurality of candidate streamer profiles. The remote server then sends the live stream request to the corresponding computing device of the closest profile. If an acceptance is received by the remote server from the corresponding computing device of the closest profile, the closest profile is selected as the confirmed streamer profile. If a rejection is received by the remote server from the corresponding computing device of the closest profile, a next closest profile is identified from the plurality of candidate streamer profiles. The current device location of the next closest profile is second closest to the specified stream location among the current device locations of the corresponding computing devices of the plurality of candidate streamer profiles. If an acceptance is received by the remote server from the corresponding computing device of the next closest profile, the next closest profile is selected by the remote server as the confirmed streamer profile.

In some embodiments, if a rejection is received by the remote server from the corresponding computing device of the closest profile, the closest profile is removed from the plurality of candidate steamer profiles, and a new closest profile is identified from the plurality of candidate streamer profiles with the remote server, wherein the current device location of the computing device of the new closest profile is closest to the specified stream location among the current device locations of the corresponding computing devices of the plurality of candidate streamer profiles. In any case, in general terms, if the closest profile rejects the live stream offer or does not respond within a given window, for example 30 seconds, the next closest profile is offered the live stream job. This process continues and repeats until an acceptance is received for the live stream request. It should be noted, however, that the mechanism of selection of the confirmed streamer profile should not be limited to determination by proximity to the live stream location, and may be determined by other factors in different embodiments. For example, in some embodiments, the viewer profile may be presented with a list of candidate streamer profiles from which the viewer profile may be permitted to select a profile to offer the live stream request to. In some embodiments, various other factors may be utilized to automatically select which of the plurality of candidate streamer profiles to offer the live stream request to, such as number of completed stream requests, user rating, or other factors.

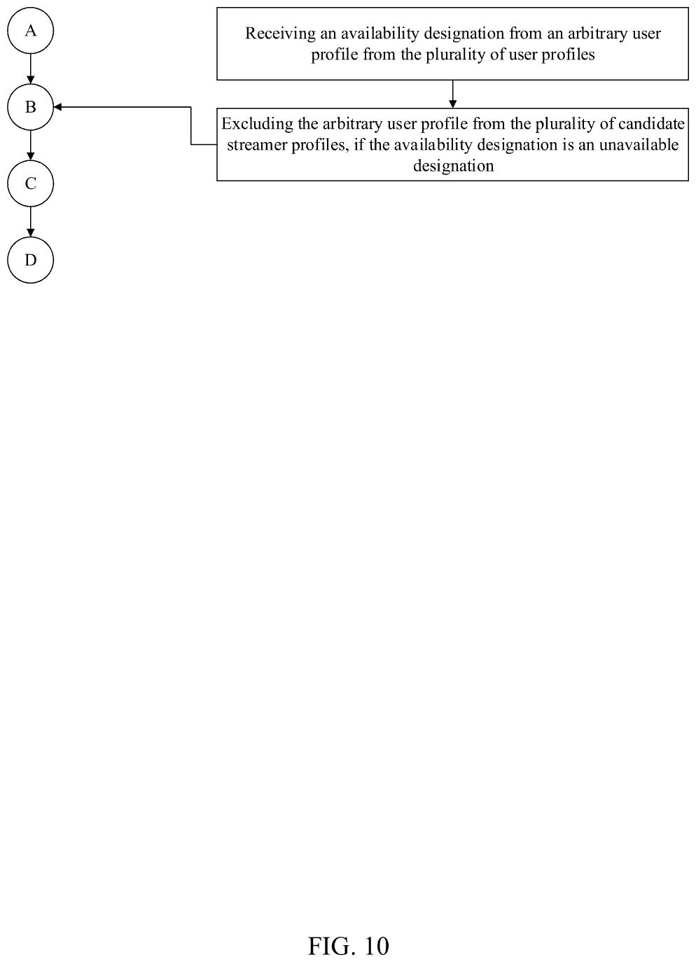

In the preferred embodiment, users may mark themselves as available or unavailable through the app of the present invention. Thus, an availability designation may be received from an arbitrary user profile from the plurality of user profiles, as described in FIG. 10. The arbitrary user profile may be any of the plurality of user profiles that may potentially take on the role of a streamer. The arbitrary user profile is thus excluded from the plurality of candidate streamer profiles during the streamer selection process, if the availability designation received from the arbitrary user profile is an unavailable designation.

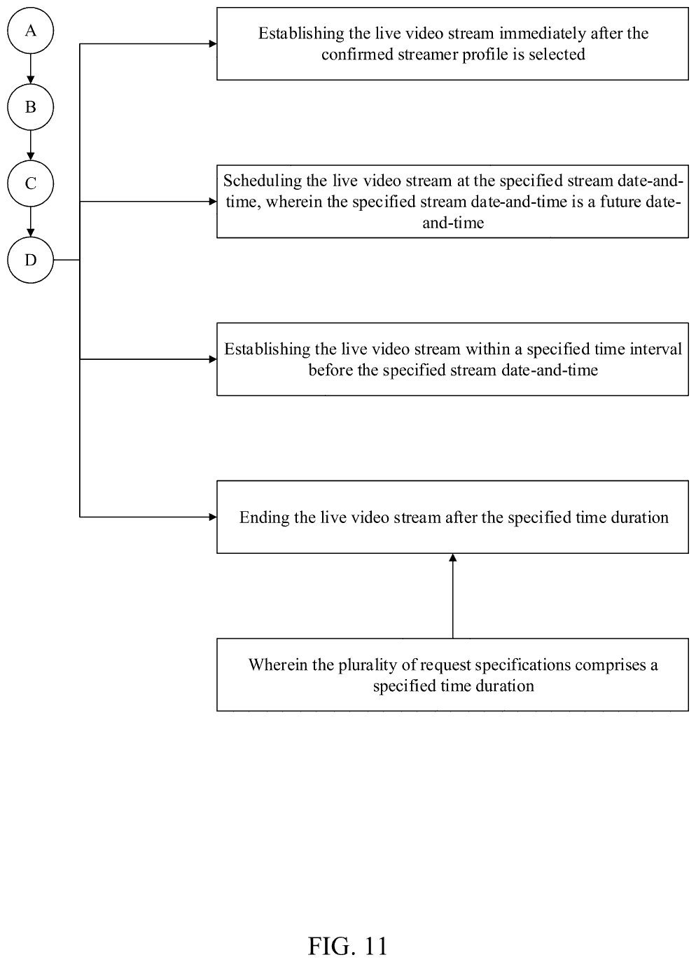

After an acceptance is received for the live stream request and the confirmed streamer profile is selected, a live video stream subsequently is established from the camera of the corresponding computing device of the confirmed streamer profile to the corresponding computing device of the viewer profile (Step D). As previously mentioned, the present invention contemplates two primary stream types: immediate and scheduled. An immediate stream is started as soon as possible after the request is accepted. More particularly, referring to FIG. 11, the live video stream is established immediately after the confirmed streamer profile is selected, or immediately after the acceptance is received. Furthermore, in some embodiments, the live video stream may be restricted from starting while the current device location of the computing device of the confirmed streamer profile is outside a certain radius of the specified stream location, for example, 100 meters. This measure is intended to prevent streamers from abusing the system through charging by streaming time even though the streamer is not at the specified stream location.

A scheduled stream is started at the specified date-and-time; more particularly, the live video stream is scheduled at the specified stream date-and-time, wherein the specified stream data-and-time is a future date-and-time. For example, at 2:00 PM, the viewer profile requests a live stream at 5:00 PM; thus, the live video stream is established at 5:00 PM. In some embodiments, the live video stream may be established within a specified time interval before the specified stream date-and-time to ensure adequate preparation for viewing the subject of the stream. Modifying the previous example, in this case, the live video stream may be started at 4:55 PM.

In some embodiments, the duration of the live video stream may depend on the amount of money paid by the viewer profile. In some embodiments, viewers may purchase various increments of streaming time or levels of service. To this end, the plurality of request specifications may comprise a specified time duration, after which the live video stream is ended. For example, a 30-minute stream may cost $10. At the end of the 30 minutes, the stream may automatically terminate, or the viewer may be offered the opportunity to continue the stream by purchasing more streaming time.

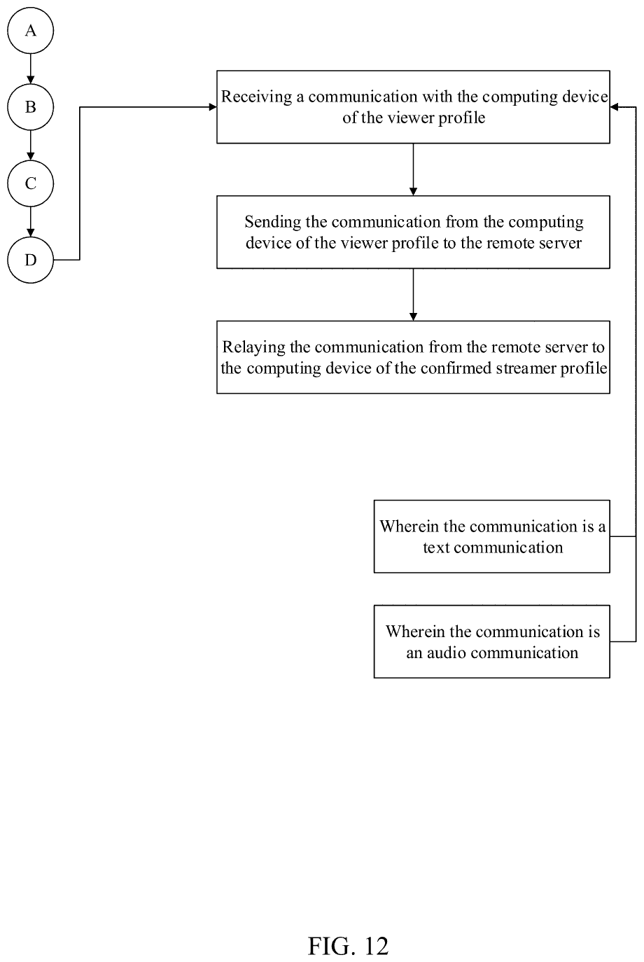

In the preferred embodiment, the viewer is able to communicate with the streamer and vice-versa through the app of the present invention. The viewer may wish to give the streamer instructions as to where to point their camera, for example, or ask the streamer questions about the subject of the stream, their environment, or other subjects. Thus, referring to FIG. 12, a communication may be received with the computing device of the viewer profile. The communication is sent from the computing device of the viewer profile to the remote server, and subsequently the communication is relayed from the remote server to the computing device of the confirmed streamer profile. The reverse may also be facilitated, in that the streamer may input a communication into their computing device which is then relayed to the computing device of the viewer. In various embodiments, the nature of the communication may vary, and may include various types of communication. In some embodiments, the communication may comprise a text communication. In some embodiments, the communication may comprise an audio communication. In some embodiments, the communication may comprise an image communication.

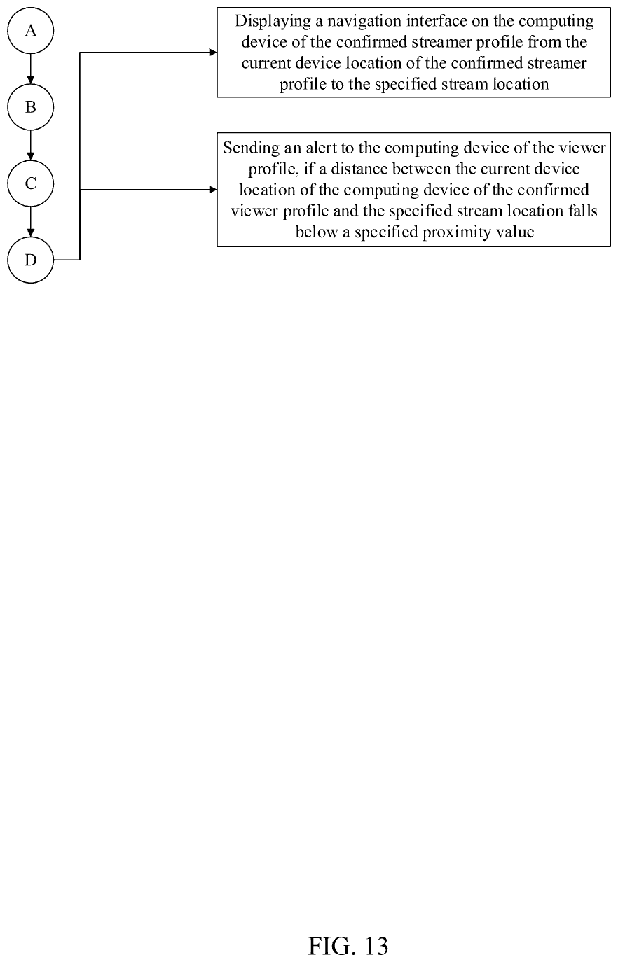

Referring to FIG. 13, in the preferred embodiment, after the confirmed streamer profile is selected and the streamer is ready to prepare to execute the live video stream, a navigation interface may be displayed on the computing device of the confirmed streamer profile in order to guide the streamer from the current device location of the computing device of the confirmed streamer profile to the specified stream location. Any relevant and useful navigation interface may be utilized, such as, but not limited to, a list of directions, a live navigation interface, or others. Further, third-party applications may be integrated into the present invention for use as the navigation interface. Moreover, as the specified stream time-and-date approaches and the streamer makes their way to the specified stream location, the viewer profile may be notified. For example, an alert may be sent by the remote server to the computing device of the viewer profile, if a distance between the current device location of the computing device of the confirmed viewer profile and the specified stream location falls below a specified proximity value.

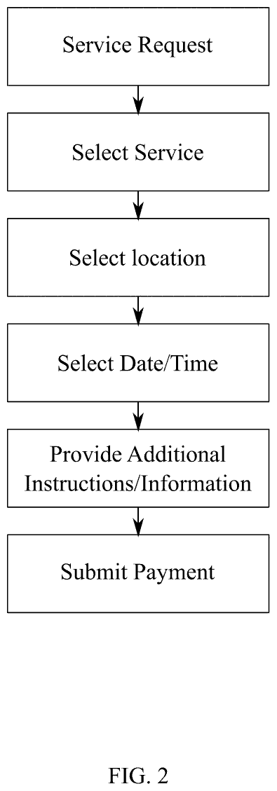

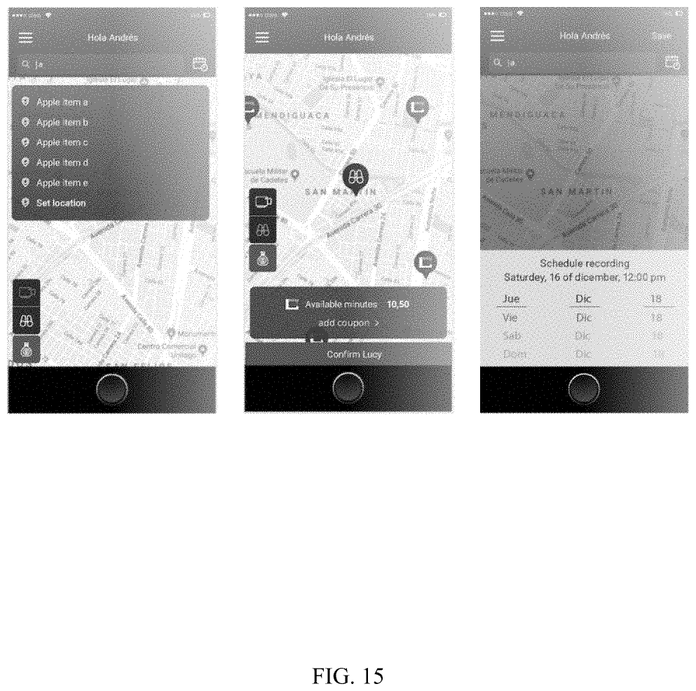

The following is a supplemental overview of the present invention intended to further illustrate the spirit of the present invention, and is not intended to be limiting. In the preferred embodiment of the present invention, the application of the present invention allows users to request a video live stream immediately or schedule the stream for a later day. As seen in FIGS. 1 and 15, a first user may submit a request for a video live stream through the application of the present invention. As can be seen in FIGS. 2 and 15, the request for the video live stream may include, but is not limited to, the location of the stream, the type of stream desire, additional instructions, etc. The request is sent to a one or more database which processes the request and identifies the plurality of users available close to the location of the video live stream. Each user close to the stream location is offered the available request for a preset period of time. The closest user is offered the request first, and the next closest user is offered the request if the first user declines the offer, and so on.

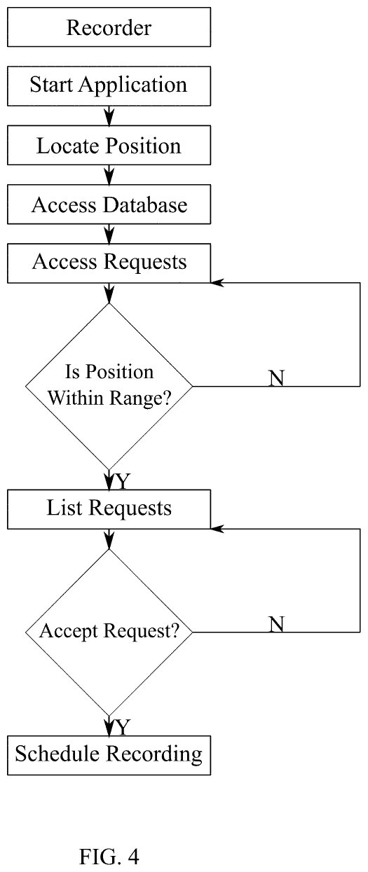

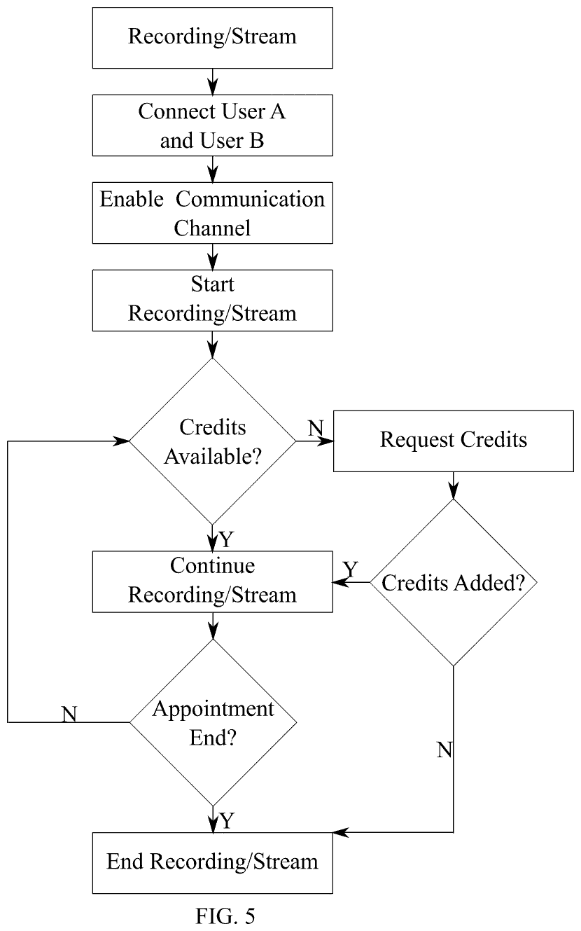

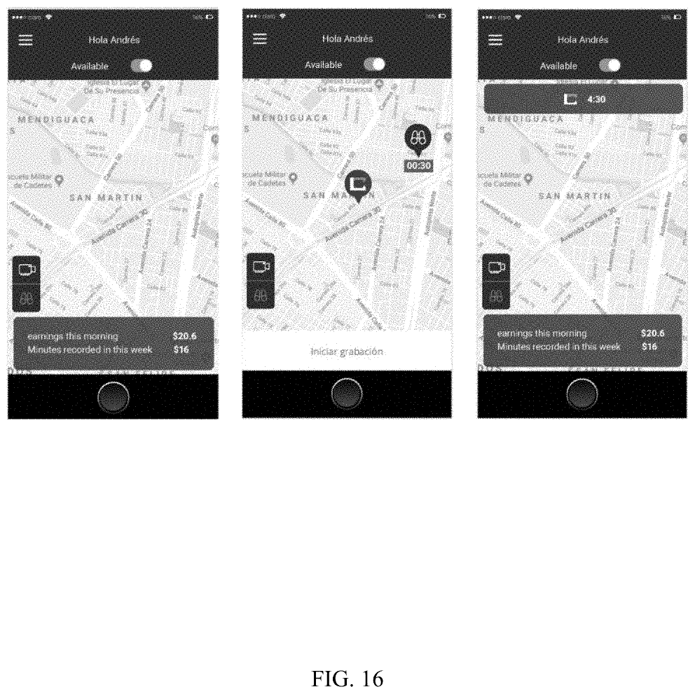

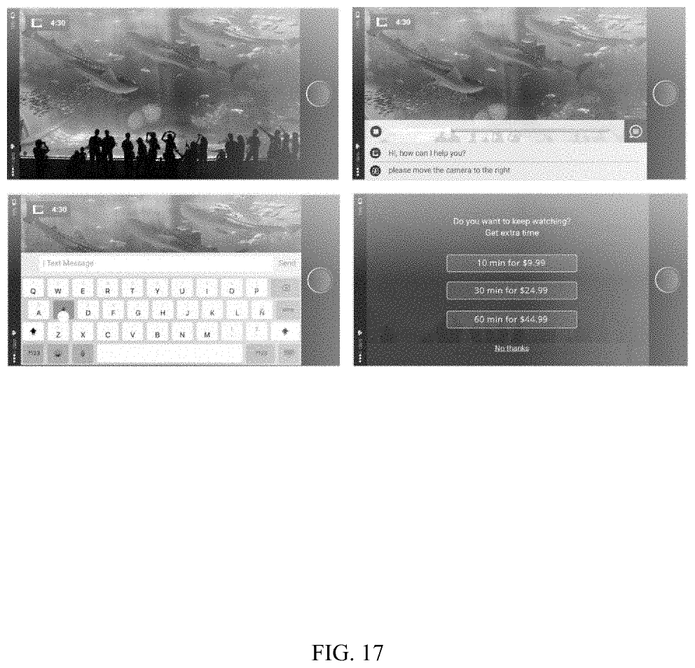

As seen in FIGS. 4 and 16, once a second user accepts the request, the request is completely processed and scheduled. The second user can receive multiple request offers based on the proximity of the second user to the location of the video live stream request. The second user can choose from a plurality of requests depending on the second user's availability and performance. As seen in FIG. 16, the second user who accepted the request can keep track of the accepted requests and the application of the present invention can notify the second user of upcoming scheduled requests. As seen in FIGS. 5 and 17, When the scheduled video live stream is about to start, the application of the present invention connects the first user with the second user.

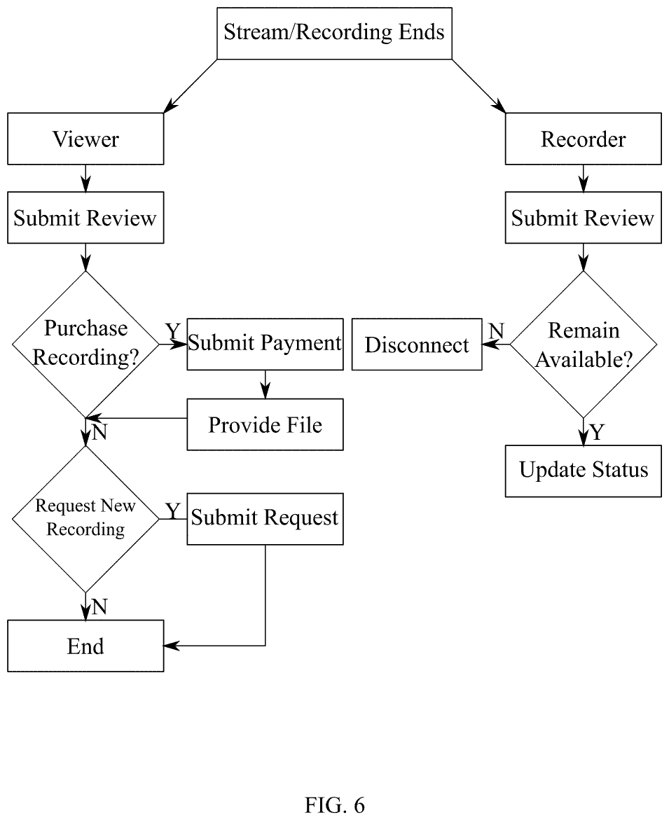

As seen in FIG. 17, the application of the present invention further provides a communication channel between the first user and the second user in order to communicate during the video live stream. In the preferred embodiment of the present invention, the communication channel can include various communication methods including, but not limited to, texting, voice, pings, etc. If the first user were to run out of credits during the video live stream or wished to extend the video live stream, the application of the present invention can provide notifications to alert the plurality of users as well as an option for the first user to obtain more credits, as seen in FIG. 17. The first user can end the video live stream, or the stream can automatically end at the scheduled time. As can be seen in FIG. 6, after the video live stream ends, the first user is provided the option to submit a review of the second user's performance. Furthermore, the first user is provided with the option to purchase a recording of the video live stream, so the first user can download it for later view. The first user is provided with an option to request an additional video live stream. On the other hand, after the video live stream ends, the second user is provided with the option to submit a review of the first user. Additionally, the second user is provided with the option to remain available for additional video live streams after the first video live stream ends.

In the preferred embodiment of the present invention, the application of the present invention further provides a library for users to manage recordings of previous video live streams. The application of the present invention can further provide a management service for users to keep track of video live stream services provided and earnings from stream services provided. The application of the present invention can further connect a plurality of users to video live stream from multiple devices. In alternate embodiments of the present invention, the present invention can further be adapted to provide live streams in different media such as pictures.

Although the invention has been explained in relation to its preferred embodiment, it is to be understood that many other possible modifications and variations can be made without departing from the spirit and scope of the invention as hereinafter claimed.

What is claimed is:

1. A method of implementing a peer-to-peer on-demand live video streaming service comprises the steps of:
providing a plurality of user profiles managed by a remote server, wherein each of the plurality of user profiles is associated with a corresponding computing device,
wherein each corresponding computing device transmits a current device location to the remote server, and
wherein each corresponding computing device comprises a camera;
providing a viewer profile from the plurality of user profiles;
(A) receiving a live stream request from the corresponding computing device of the viewer profile with the remote server,
wherein the live stream request comprises a plurality of request specifications, and
wherein the plurality of request specifications comprises a specified stream location and a specified stream date-and-time;
(B) identifying a plurality of candidate streamer profiles from the plurality of user profiles with the remote server, wherein the current device location of the corresponding computing device of each candidate streamer profile is within a specified radius of the specified stream location;
(C) selecting a confirmed streamer profile from the plurality of candidate streamer profiles with the remote server; and
(D) establishing a live video stream from the camera of the corresponding computing device of the confirmed streamer profile to the corresponding computing device of the viewer profile.

2. The method of implementing a peer-to-peer on-demand live video streaming service as claimed in claim 1, wherein the plurality of request specifications further comprises a service type.

3. The method of implementing a peer-to-peer on-demand live video streaming service as claimed in claim 1 comprises the steps of:
identifying a closest profile from the plurality of candidate streamer profiles with the remote server, wherein the current device location of the computing device of the closest profile is closest to the specified stream location among the current device locations of the corresponding computing devices of the plurality of candidate streamer profiles; and
sending a live stream request to the corresponding computing device of the closest profile with the remote server.

4. The method of implementing a peer-to-peer on-demand live video streaming service as claimed in claim 3 comprises the steps of:
receiving an acceptance from the corresponding computing device of the closest profile with the remote server; and
selecting the closest profile as the confirmed streamer profile with the remote server, if the acceptance is received.

5. The method of implementing a peer-to-peer on-demand live video streaming service as claimed in claim 3 comprises the steps of:
receiving a rejection from the corresponding computing device of the closest profile with the remote server;
identifying a next closest profile from the plurality of candidate streamer profiles with the remote server, wherein the current device location of the next closest profile is second closest to the specified stream location among the current device locations of the corresponding computing devices of the plurality of candidate streamer profiles;
receiving an acceptance from the corresponding computing device of the next closest profile with the remote server; and
selecting the next closest profile as the confirmed streamer profile, if the acceptance is received.

6. The method of implementing a peer-to-peer on-demand live video streaming service as claimed in claim 3 comprises the steps of:
receiving a rejection from the corresponding computing device of the closest profile with the remote server;
removing the closest profile from the plurality of candidate streamer profiles; and
identifying a new closest profile from the candidate streamer profiles with the remote server, wherein the current device location of the computing device of the new closest profile is closest to the specified stream location among the current device locations of the corresponding computing devices of the plurality of candidate streamer profiles.

7. The method of implementing a peer-to-peer on-demand live video streaming service as claimed in claim 1 comprises the step of:
establishing the live video stream within a specified time interval before the specified stream date-and-time.

8. The method of implementing a peer-to-peer on-demand live video streaming service as claimed in claim 1 comprises the step of:
scheduling the live video stream at the specified stream date-and-time, wherein the specified stream date-and-time is a future date-and-time.

9. The method of implementing a peer-to-peer on-demand live video streaming service as claimed in claim 1 comprises the step of:
establishing the live video stream immediately after the confirmed streamer profile is selected.

10. The method of implementing a peer-to-peer on-demand live video streaming service as claimed in claim 1 comprises the steps of:
receiving a communication with the computing device of the viewer profile;
sending the communication from the computing device of the viewer profile to the remote server; and
relaying the communication from the remote server to the computing device of the confirmed streamer profile.

11. The method of implementing a peer-to-peer on-demand live video streaming service as claimed in claim 10, wherein the communication is a text communication.

12. The method of implementing a peer-to-peer on-demand live video streaming service as claimed in claim 10, wherein the communication is an audio communication.

13. The method of implementing a peer-to-peer on-demand live video streaming service as claimed in claim 1 comprises the steps of:
wherein the plurality of request specifications comprises a specified time duration;
ending the live video stream after the specified time duration.

14. The method of implementing a peer-to-peer on-demand live video streaming service as claimed in claim 1 comprises the steps of:
receiving an availability designation from an arbitrary user profile from the plurality of user profiles; and
excluding the arbitrary user profile from the plurality of candidate streamer profiles, if the availability designation is an unavailable designation.

15. The method of implementing a peer-to-peer on-demand live video streaming service as claimed in claim 1 wherein the specified radius corresponds to an estimated walking distance from the current device location to the specified stream location.

16. The method of implementing a peer-to-peer on-demand live video streaming service as claimed in claim 1 comprises the step of:
displaying a navigation interface on the computing device of the confirmed streamer profile from the current device location of the confirmed streamer profile to the specified stream location.

17. The method of implementing a peer-to-peer on-demand live video streaming service as claimed in claim 1 comprises the step of:
sending an alert to the computing device of the viewer profile, if a distance between the current device location of the computing device of the confirmed viewer profile and the specified stream location falls below a specified proximity value.
